(19) United States
(12) Patent Application Publication
(10) Pub. No.: US 2009/0146477 A1
(43) Pub. Date: Jun. 11, 2009

(54) THICKNESS OF A SEAT CUSHION AT THE BACK SIDE OF A SEAT CUSHION FRAME

(76) Inventors: Masayuki Yamada, Aichi (JP); Hideki Kobayashi, Aichi (JP); Takeshi Toukai, Aichi (JP); Masaki Mori, Gifu (JP); Keisuke Onoda, Aichi (JP); Makoto Ito, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/089,613

(22) PCT Filed: Oct. 11, 2006
(86) PCT No.: PCT/JP2006/320336

§ 371 Date: Apr. 9, 2008

(30) Foreign Application Priority Data
Oct. 11, 2005 (JP) 2005-296846

(51) Int. Cl. B60N 2/00

(52) U.S. Cl. 297/354.1

(57) ABSTRACT

In a seat (10), a seat back (14) tilts forward to be superposed on a seat cushion (20) and thereby the seat (10) is stowed. In this stowage operation, an arm (26) and a cushion main frame (22) are moved forward by a back frame (16), rotating a front link (28) forward. The operation reduces the distance in the vertical direction between a position at which the front link (28) is connected to the cushion main frame (22) and a restriction shaft (30), so that the distance in the vertical direction between the cushion main frame (22) and a lower wall of an under cover (32) can be reduced. As a result, the under cover (32) contacts with a vehicle compartment floor surface (12) and a seat cushion body (24) is inserted inside the under cover (32). This allows the thickness of the seat cushion (20) to be reduced at the back side of the cushion main frame (22).

### TECHNICAL FIELD

The present invention relates to a seat structure and a seat extension/retraction method, which are capable of extending and retracting the thickness of a seat cushion, and a vehicle comprising the seat structure.

### BACKGROUND ART

As a seat structure, proposed has been one in which right and left seat side sections in a seat cushion are made capable of moving to higher and lower locations, respectively, with respect to a center top plate section to enable the thickness of the seat cushion to be extended and retracted (refer to Patent Reference 1, for example).

In the above seat structure, however, the thickness of the seat cushion is only made capable of extension and retraction on the surface side of a seat cushion frame. The thickness of the seat cushion can be effectively extended and retracted when the thickness can be extended and retracted also at the back side of the seat cushion frame.

Patent Reference 1: JP-A-2000-316663

### DISCLOSURE OF THE INVENTION

In view of the above, an object of the invention is to achieve a seat structure, a seat extension/retraction method and a vehicle, which are capable of extending and retracting the thickness of a seat cushion at the back side of a seat cushion frame.

A seat structure according to claim 1 comprises: a seat cushion frame provided in a seat cushion; a back side member provided to the seat cushion at the back side of the seat cushion frame to be connected to the seat cushion frame independently from support of the seat cushion frame on a vehicle body side; and a link mechanism for moving the back side member to extend/retract a distance between the seat cushion frame and the back side member in the thickness direction of the seat cushion.

In the seat structure according to claim 1, the seat cushion frame is provided in the seat cushion while the back side member is provided to the seat cushion at the back side of the seat cushion frame.

In the above structure, the link mechanism extends/retracts the distance between the seat cushion frame and the back side member in the thickness direction of the seat cushion. This allows the thickness of the seat cushion to be extended/retracted at the back side of the seat cushion frame.

A seat structure according to claim 2 is characterized in that the link mechanism includes: a link rotatably connected to the vehicle body side and rotatably connected to one of the seat cushion frame or the back side member; and a contact part provided to the link that contacts with the other of the seat cushion frame or the back side member and that separates the other of the seat cushion frame or the back side member from the one of the seat cushion frame or the back side member, in the seat structure according to claim 1.

In the seat structure according to claim 2, the link rotatably connected to the vehicle body side is rotatably connected to the one of the seat cushion frame or the back side member. Further, the contact part provided to the link contacts with the other of the seat cushion frame or the back side member and separates the other of the seat cushion frame or the back side back.

A seat structure according to claim 16 is characterized by operating the link mechanism in accordance with a rotation of the seat cushion frame with respect to the vehicle body side, in the seat structure according to claim 1.

A seat structure according to claim 17 is characterized in that the link mechanism includes: a third link rotatably connected to the vehicle body side and connected to the seat cushion frame; and a fourth link rotatably connected to the vehicle body side at a position offset with respect to the center of rotation of the third link and connected to the back side member, in the seat structure according to claim 16.

In the seat structure according to claim 17, the third link rotatably connected to the vehicle body side is connected to the seat cushion frame. Further, the fourth link rotatably connected to the vehicle body side at the position offset with respect to the center of rotation of the third link is connected to the back side member.

Accordingly, rotating the seat cushion to rotate the third link and the fourth link causes a distance in the thickness direction of the seat cushion between a connection position at which the third link is connected to the seat cushion frame and a connection position at which the fourth link is connected to the back side member to be extended/retracted, so that the distance in the thickness direction of the seat cushion between the seat cushion frame and the back side member is extended/retracted. This allows the thickness of the seat cushion to be extended/retracted in accordance with a rotation of the seat cushion.

A seat structure according to claim 18 is characterized in that the link mechanism includes: a first connection part that rotatably connects the seat cushion frame to the vehicle body side; and a second connection part that rotatably connects the back side member to the vehicle body side at a position offset with respect to the center of rotation of the seat cushion frame, in the seat structure according to claim 16.

In the seat structure according to claim 18, the seat cushion frame is rotatably connected to the vehicle body by means of the first connection part. Moreover, the back side member is rotatably connected to the vehicle body side at the position offset with respect to the center of rotation of the seat cushion frame by means of the second connection part.

Accordingly, rotating the seat cushion to rotate the seat cushion frame and the back side member causes the distance in the thickness direction of the seat cushion between the seat cushion frame and the back side member to be extended/retracted. This allows the thickness of the seat cushion to be extended/retracted in accordance with a rotation of the seat cushion.

A seat structure according to claim 19 is characterized in that the link mechanism includes: a third connection part for rotatably connecting one of the seat cushion frame or the back side member to the vehicle body side; a fifth link rotatably connected to the vehicle body side at a position offset with respect to the center of rotation of the one of the seat cushion frame or the back side member and slidably connected to the other of the seat cushion frame or the back side member; and a sixth link rotatably connected to the one of the seat cushion frame or the back side member and rotatably connected to the fifth link, in the seat structure according to claim 16.

In the seat structure according to claim 19, the one of the seat cushion frame or the back side member is rotatably connected to the vehicle body side by means of the third connection part. Further, the fifth link rotatably connected to the vehicle body side at the position offset with respect to the center of rotation of the one of the seat cushion frame or the back side member is slidably connected to the other of the seat cushion frame or the back side member. Moreover, the sixth link rotatably connected to the one of the seat cushion frame or the back side member is rotatably connected to the fifth link.

Accordingly, rotating the seat cushion to rotate the seat cushion frame, the back side member and the fifth link causes the sixth link to be rotated and slid through the fifth link, so that the distance in the thickness direction of the seat cushion between the seat cushion frame and the back side member is extended/retracted. This allows the thickness of the seat cushion to be extended/retracted in accordance with a rotation of the seat cushion.

A seat structure according to claim 20 is characterized by further comprising a cover member for covering an outer circumferential surface of the back side member, in the seat structure according to any one of claims 1 to 3 and 16 to 19.

In the seat structure according to claim 20, the outer circumferential surface of the back side member is covered with the cover member. This allows the appearance to look attractive.

A seat extension/retraction method according to claim 8 comprises: in a seat structure comprising a seat cushion frame provided in a seat cushion and a back side member provided to the seat cushion at the back side of the seat cushion frame to be connected to the seat cushion frame independently from support of the seat cushion frame on a vehicle body side, moving the back side member to extend/retract a distance between the seat cushion frame and the back side member in a thickness direction of the seat cushion via a link mechanism.

A vehicle according to claim 15 is provided with a seat having the seat structure according to claim 1.

### BRIEF DESCRIPTION OF THE DRAWINGS

FIG. 1 is a left side view of an integral part of a seat in accordance with a first embodiment of the invention.

FIG. 2 is a perspective view from the obliquely left and front side, the view showing an integral part of a seat in accordance with a first embodiment of the invention.

FIG. 3A is a left side view of a seat in accordance with a first embodiment of the invention.

FIG. 3B is a left side view showing a state of stowage of a seat in accordance with a first embodiment of the invention.

FIG. 3C is a left side view showing a state of stowage of a seat in accordance with a second embodiment of the invention.

FIG. 4 is a perspective view from the obliquely left and front side, the view showing an integral part of a seat in accordance with another example of the first embodiment of the invention.

FIG. 5 is a perspective view from the obliquely left and front side, the view showing a state of stowage of a seat in accordance with another example of the first embodiment of the invention.

FIG. 6 is a left side view of an integral part of a seat in accordance with a second embodiment of the invention.

FIG. 7 is a left side view of an integral part of a seat in accordance with a third embodiment of the invention.

FIG. 8 is a left side view of an integral part of a seat in accordance with a fourth embodiment of the invention.

FIG. 9 is a left side view showing a state of stowage of a seat in accordance with a fourth embodiment of the invention.

FIG. 10A is a left side view showing a state of tumble-storage of a seat in accordance with a fourth embodiment of the invention.

FIG. 10B is a perspective view from the obliquely front side, the view showing a state of space-increased storage of a seat in accordance with a fourth embodiment of the invention.

FIG. 10C is a perspective view from the obliquely rear side, the view showing a state of rear-side under-floor storage of a seat in accordance with a fourth embodiment of the invention.

FIG. 11 is a left side view of an integral part of a seat in accordance with a fifth embodiment of the invention.

FIG. 12 is a left side view of an integral part of a seat in accordance with a sixth embodiment of the invention.

FIG. 13A is a left side view showing a state of stowage of a seat in accordance with a sixth embodiment of the invention.

FIG. 13B is a left side view showing a state of stowage of a seat in accordance with a seventh embodiment of the invention.

FIG. 14 is a left side view of an integral part of a seat in accordance with a seventh embodiment of the invention.

FIG. 15 is a perspective view from the obliquely left and rear side, the view showing an integral part of a seat in accordance with a seventh embodiment of the invention.

FIG. 16 is a left side view of an integral part of a seat in accordance with an eighth embodiment of the invention.

FIG. 17 is a left side view of an integral part of a seat in accordance with a ninth embodiment of the invention.

FIG. 18 is a perspective view from the obliquely left and front side, the view showing states of stowage and storage of a seat in accordance with a ninth embodiment of the invention.

FIG. 19 is a left side view of an integral part of a seat in accordance with a tenth embodiment of the invention.

### BEST MODE FOR CARRYING OUT THE INVENTION

### First Embodiment

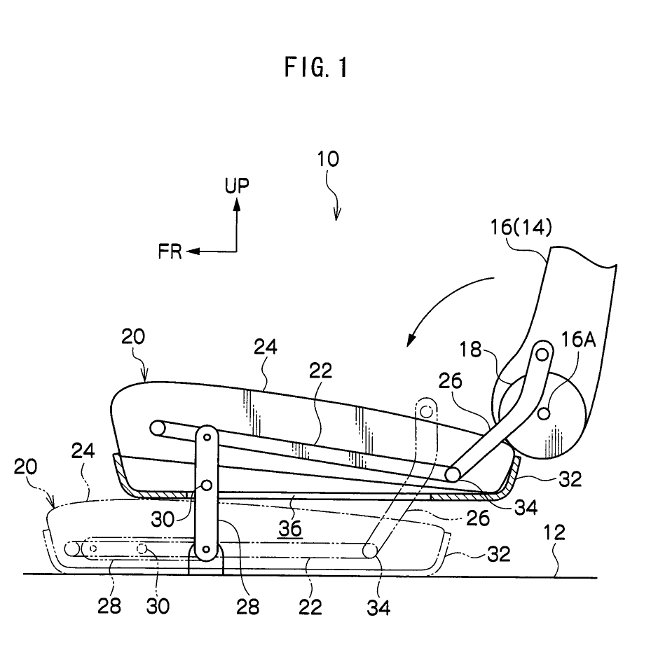

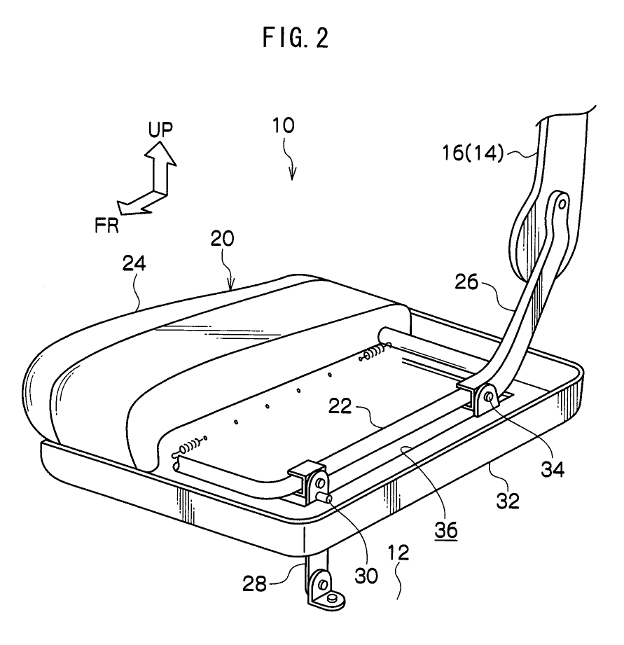

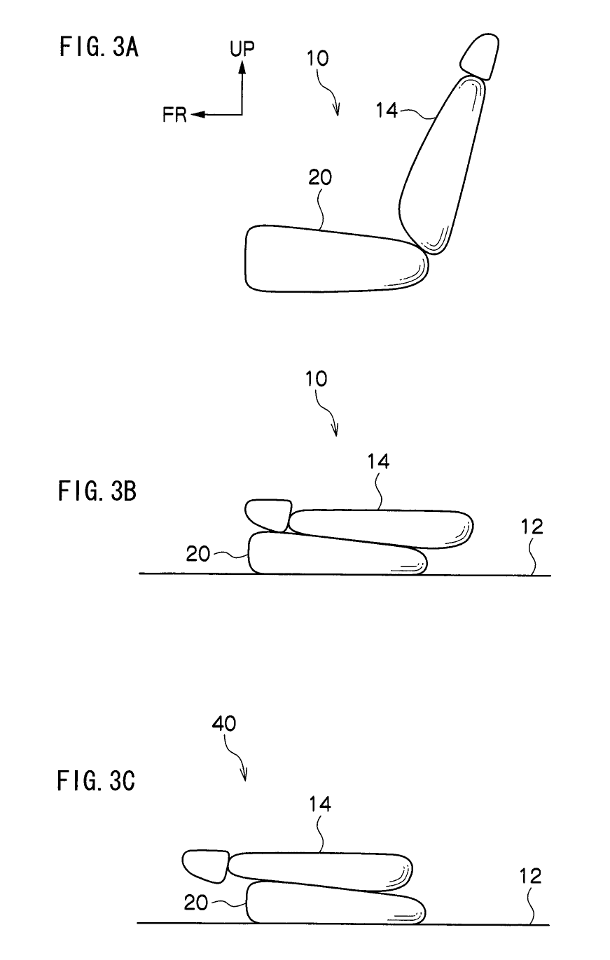

FIG. 1 is a left side view of an integral part of a seat 10 in accordance with a first embodiment of the invention, the seat 10 arranged so that a seat structure in accordance with the invention would be applied to. FIG. 2 is a perspective view from the obliquely left and front side, the view showing an integral part of the seat 10. Further, FIG. 3A is a left side view of the seat 10. In the drawings, an arrow FR shows a forward direction of the seat 10 while an arrow UP shows an upper direction of the seat 10.

The seat 10 in accordance with a first embodiment is for a vehicle and provided on a vehicle compartment floor surface 12 of the vehicle. The seat 10 is a so-called forward tilt-down stowage type seat.

The seat 10 is provided with a seat back 14. Inside both of the right and left ends of the seat back 14, provided is a plate-shaped back frame 16. Supporting a lower end of the back frame 16 on a vehicle body side so as to be tiltable upon a rotation center shaft 16A allows the seat back 14 to be supported on the vehicle body side so as to be tiltable upon the rotation center shaft 16A. At the lower end of the back frame 16, provided is a reclining mechanism 18. The reclining mechanism 18 stops a tilt of the back frame 16 upon the rotation center shaft 16A to stop a tilt of the seat back 14 upon the tilt center shaft 16A, so that the seat back 14 is raised upward. Further, operating the reclining mechanism 18 causes the reclining mechanism 18 to allow the back frame 16 to tilt upon the rotation center shaft 16A, and thereby, the seat back 14 to tilt upon the tilt center shaft 16A.

On the front side of the seat back 14, provided is a seat cushion 20. The seat cushion 20 is arranged substantially horizontally with its rear end being located in the vicinity of a lower side of the seat back 14.

In the seat cushion 20, provided as a cushion main frame is a cushion main frame 22 in the shape of a rectangular frame. The cushion main frame 22 holds a seat cushion body 24. The seat cushion body 24 has spring and forms an upper surface (a surface) of the seat cushion 20.

A lower end of an arm 26 is connected to a rear part of the cushion main frame 22 on both of the right and left sides so as not to be rotatable. An upper end of the arm 26 is rotatably connected to a lower part of the back frame 16. A front part of the cushion main frame 22 is connected to an upper end of a front link 28, which functions as a link forming a link mechanism, on both of the right and left sides so that the upper end of the front link 28 would be rotatable. A lower end of the front link 28 is connected to the vehicle body so as to be rotatable. This allows the cushion main frame 22 to be supported on the arm 26 and the front link 28 and the seat cushion 20 to be supported on a vehicle body side. A restriction shaft 30 in the shape of a circular shaft, which functions as a contact part forming the link mechanism, is fixed to a vertically middle part of the front link 28. The restriction shaft 30 projects outward in the left-and-right direction from the front link 28.

Under the cushion main frame 22 (at the back side of the seat cushion 20), provided is an under cover 32 as a back side member. The under cover 32 is formed into the shape of a substantially rectangular parallelepiped container whose upper surface is opened. A rear part of a bottom wall of the under cover 32 is rotatably connected on both of the right and left side parts thereof to both of the right and left side parts of a rear part of the cushion main frame 22, respectively, by means of a connection part 34 (a connection shaft). In the middle of the bottom wall of the under cover 32, formed is a rectangular opening 36 so as to pass through the bottom wall. Inserting the front link 28 into the opening 36 allows the cushion main frame 22 and the vehicle body side to be connected by means of the front link 28. The under cover 32 is interlocked with the seat cushion body 24 so that a downward movement of the under cover 32 would be limited. This causes the under cover 32 to cover the lower sides of the cushion main frame 22 and the seat cushion body 24. Further, the bottom wall of the under cover 32 is separated from the main cushion frame 22 while a gap is formed between the bottom wall of the under cover 32 and a lower surface of the seat cushion body 24. The bottom wall of the under cover 32 is, on the upper side thereof, in contact with the restriction shaft 30 of the front link 28. This limits an upward movement of the under cover 32.

The whole outer circumferential surface of the under cover 32 is covered with an outer layer (not shown), which is a covering member. This allows the under cover 32, and thereby, the seat cushion 20 to look attractive.

Now, described will be an operation of the first embodiment.

In the seat 10 having the above structure, operating the reclining mechanism 18 to tilt the seat back 14 forward upon the tilt center shaft 16A causes the seat back 14 to be superposed on the seat cushion 20 for stowage (refer to FIG. 3B).

In the stowage of the seat 10, the back frame 16 (the seat back 14) is tilted forward upon the tilt center shaft 16A, moving the cushion main frame 22 (the seat cushion 20) forward through the arm 26. This causes the front link 28 to be rotated forward to rotate the seat cushion 20 forward and downward.

Further, when the seat 10 is stowed, a forward rotation of the front link 28 causes a distance in the vertical direction (a thickness direction of the seat cushion 20) between a position at which the front link 28 is connected to the cushion main frame 22 and the restriction shaft 30 to be reduced, so that a distance in the vertical direction between the cushion main frame 22 and the bottom wall of the under cover 32 can be reduced. This causes the seat cushion body 24 to be inserted in the under cover 32 until the bottom wall of the under cover 32 is made contact with the vehicle compartment floor surface 12 to rotate the cushion main frame 22 downward toward the bottom wall of the under cover 32, and thereby, to make a bottom surface of the seat cushion body 24 in contact with the bottom wall of the under cover 32. Therefore, the thickness of the seat cushion 20 can be reduced at the back side of the cushion main frame 22 in accordance with stowage of the seat 10 even in the case that the thickness of the seat cushion 20 in an usual use is increased. This allows a space (a space above the seat 10) of a vehicle compartment (a baggage compartment) to be made large in stowing the seat 10.

### Second Embodiment

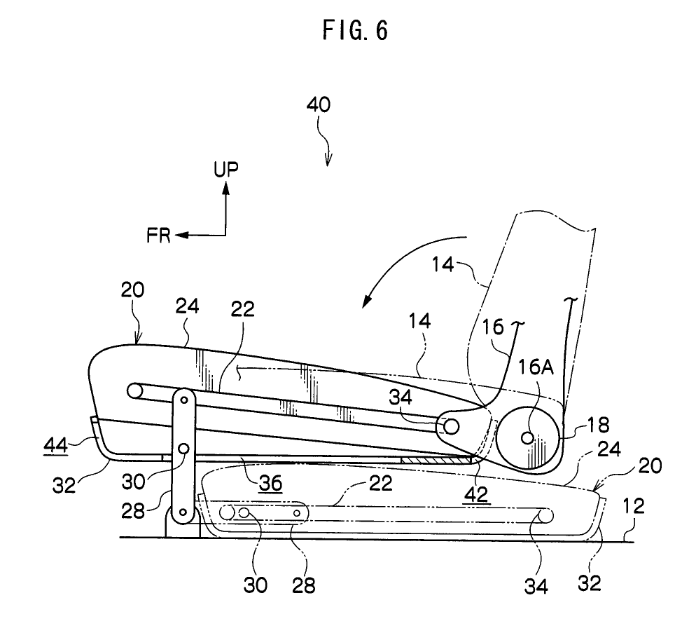

FIG. 6 is a left side view of an integral part of a seat 40 in accordance with a second embodiment, the seat 40 being arranged so that a seat structure in accordance with the invention would be applied to.

The seat 40 in accordance with the second embodiment is almost same in structure as the first embodiment but different in the following point.

The seat 40 in accordance with the second embodiment is arranged to be a so-called rear-side tilt-down stowage type seat.

A lower end of the back frame 16 extends forward and is rotatably connected to a rear part of the cushion main frame 22 at the connection part 34. This allows the cushion main frame 22 to be supported on the back frame 16 and the front link 28 and the seat cushion 20 to be supported on the vehicle body side. In the second embodiment, provided is no arm 26 in the first embodiment.

In a rear wall of the under cover 32, formed on both of the right and left sides are long rear insertion holes 42 so that the rear insertion holes 42 would pass through the rear wall of the under cover 32. The rear insertion holes 42 are provided along a vertical direction and opened upward. The lower end of the back frame 16 is inserted in the rear insertion hole 42, so that the lower end of the back frame 16 is allowed to be connected to the cushion main frame 22. From a front wall to a front part of the bottom wall of the under cover 32, formed on both of the right and left sides are long front insertion holes 44 so as to pass through the walls of the under cover 32. The front insertion holes 44 are provided along the vertical direction and the back-and-forth direction on the front side of the front link 28. The front insertion holes 44 communicate with the opening 36.

Now, described will be an operation of the second embodiment.

In the seat 40 having the above structure, operating the reclining mechanism 18 to rotate the seat back 14 forward upon the tilt center shaft 16A causes the seat back 14 to be superposed on the seat cushion 20 for stowage (refer to FIG. 3C).

In the stowage of the seat 40, the back frame 16 (the seat back 14) is tilted forward upon the tilt center shaft 16A, moving the cushion main frame 22 (the seat cushion 20) rearward. This causes the front link 28 to be rotated rearward to rotate the seat cushion 20 rearward and downward. Inserting the front link 28 into the front insertion holes 44 allows the front link 28 to be rotated rearward.

Further, when the seat 40 is stowed, a rearward rotation of the front link 28 causes the distance in the vertical direction (the thickness direction of the seat cushion 20) between the connection position at which the front link 28 is connected to the cushion main frame 22 and the restriction shaft 30 to be reduced, so that the distance in the vertical direction between the cushion main frame 22 and the bottom wall of the under cover 32 can be reduced. Accordingly, the seat cushion body 24 is inserted in the under cover 32 until the bottom wall of the under cover 32 is made contact with the vehicle compartment floor surface 12 to rotate the cushion main frame 22 downward toward the bottom wall of the under cover 32, and thereby, to make a bottom surface of the seat cushion body 24 in contact with the bottom wall of the under cover 32. Therefore, the thickness of the seat cushion 20 can be reduced at the back side of the cushion main frame 22 in accordance with stowage of the seat 40 even in the case that the thickness of the seat cushion 20 in an usual use is increased. This allows a space (a space above the seat 40) of a vehicle compartment (a baggage compartment) to be made large in stowing the seat 40.

### Third Embodiment

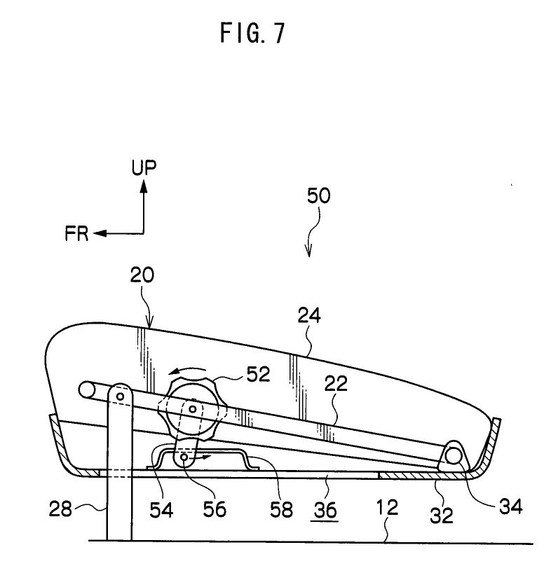

FIG. 7 is a left side view of an integral part of a seat 50 in accordance with a third embodiment, the seat 50 being arranged so that a seat structure in accordance with the invention would be applied to.

The seat 50 in accordance with the third embodiment is almost same in structure as the first embodiment but different in the following point.

In the vicinity of a front part of the cushion main frame 22, rotatably provided on both of the right and left sides (or only on the right or left side) is a cylindrical operation lever 52 functioning as an operation member. The operation lever 52 is formed from a dial type regulator or such. The operation lever 52 is provided with a rotation locking mechanism (not shown) functioning as a locking mechanism. The rotation locking mechanism interrupts a rotation of the operation lever 52. To the operation lever 52, fixed is an upper end of a rotation link 54. The rotation link 54 projects downward from the operation lever 52. A supporting shaft 56 in the shape of a circular shaft is fixed to a lower end of the rotation link 54. The supporting shaft 56 projects outward in the right-and-left direction from the rotation link 54.

The lower end of the front link 28 is connected to the vehicle body side so as not to be rotatable. No restriction shaft 30 in accordance with the first embodiment is fixed to the front link 28. Moreover, the upper end of the arm 26 is connected to the lower end of the back frame 16 rotatably upon the tilt center shaft 16A. This allows the back frame 16 to be supported on the front link 28 and the arm 26 and the seat cushion 20 to be supported on the vehicle body side.

In the vicinity of a front part of an upper surface of the bottom of wall the under cover 32, fixed on both of the right and left sides (or only on the right or left side) is a supporting plate 58, which has a cross section in the shape of a reverse U-shaped plate and functions as a supporting member. An upper wall of the supporting plate 58 is formed into the shape of a flat plate. A supporting shaft 56 of the rotation link 54 is inserted in the supporting plate 58. This allows the upper wall of the supporting plate 58 to be engaged with the supporting shaft 56, and thereby, a downward movement of the under cover 32 to be limited, so that the under cover 32 covers lower parts of the cushion main frame 22 and the seat cushion body 24.

Now, described will be an operation of the third embodiment.

In the seat 50 having the above structure, the operation lever 52 is operated for a rotation with the interruption of a rotation by the rotation locking mechanism of the operation lever 52 being released to rotate the rotation link 54. This causes a distance in the vertical direction (a direction of the thickness of the seat cushion 20) between a center of a rotation of the operation lever 52 and the supporting shaft 56 to be extended/retracted, and thereby, the distance in the vertical direction between the cushion main frame 22 and the bottom wall of the under cover 32 to be extended/retracted. Accordingly, rotating the under cover 32 upward or downward with respect to the cushion main frame 22 allows the thickness of the seat cushion 20 to be extended/retracted at the back side of the cushion main frame 22 independently from the stowage of the seat 50. Moreover, it is possible to extend/retract the distance in the vertical direction between a lower surface of the seat 50 (a lower surface of the bottom wall of the under cover 32) and the vehicle compartment floor surface 12.

### Fourth Embodiment

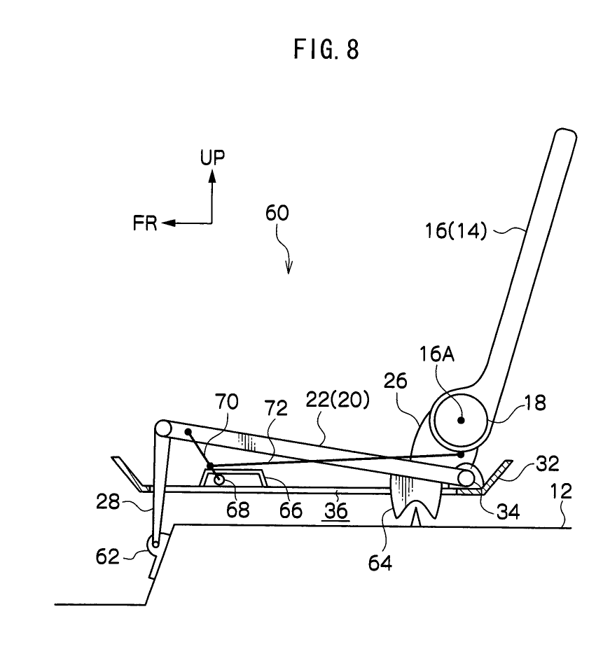

FIG. 8 is a left side view of an integral part of a seat 60 in accordance with a fourth embodiment, the seat 60 being arranged so that a seat structure in accordance with the invention would be applied to.

The seat 60 in accordance with the fourth embodiment is almost same in structure as the first embodiment but different in the following point.

In the fourth embodiment, the vehicle compartment floor surface 12 on the front side of the seat 60 is arranged to be lower than the vehicle compartment floor surface 12 just under the seat 60.

The seat 60 in accordance with the fourth embodiment is of a so-called seat back forward-tilt stowage type.

The lower end of the front link 28 is rotatably connected to a front bracket 62 on the vehicle body side. The lower end of the front link 28 can be separated from the front bracket 62. Further, the front link 28 is provided with no restriction shaft 30 in accordance with the first embodiment.

A lower side of the rear part of the cushion main frame 22 is connected on both of the right and left sides to a rear locking mechanism 64 functioning as a locking mechanism. Locking the rear locking mechanism 64 on the vehicle body side causes the cushion main frame 22 to be supported on the rear locking mechanism 64 and the front link 28, and thereby, the seat cushion 20 to be supported on the vehicle body side.

The lower end of the back frame 16 is supported on the arm 26 tiltably upon the tilt center shaft 16A. This allows the back frame 16 to be supported on the vehicle body side through the arm 26, the cushion main frame 22, the rear locking mechanism 64 and the front link 28, so that the seat back 14 is supported on the vehicle body side.

The front link 28 and the rear locking mechanism 64 are inserted into the opening 36 of the under cover 32. This allows the cushion main frame 22 to be connected to the vehicle body side by means of the front link 28 and the rear locking mechanism 64.

In the vicinity of a front part of the upper surface of the bottom wall of the under cover 32, fixed on both of the right and left sides (or only on the right or left side) is a guide plate 66, which has a cross section in the shape of a reverse U-shaped plate and functions as a guide member. An upper wall of the guide plate 66 is formed into the shape of a flat plate. In the guide plate 66, inserted is a slide shaft 68, which is in the shape of a circular shaft and functions as a slide member. The slide shaft 68 is capable of sliding between the bottom wall of the under cover 32 and the upper wall of the guide plate 66.

An end of the slide shaft 68 is connected to a lower end of a slide link 70, which functions as a first link forming the link mechanism. This allows the lower end of the slide link 70 to be slidably connected to the under cover 32. An upper end of the slide link 70 is arranged to be disposed on the front side of the lower end of the slide link 70. The upper end of the slide link 70 is rotatably connected to both of the right and left sides (or only the right or left side) of a front part of the cushion main frame 22.

A front end of an interlocking link 72, which functions as a second link forming the link mechanism, is rotatably connected to a vertically middle part of the slide link 70. A rear end of the interlocking link 72 is rotatably connected to a lower part of the seat back 14 under the tilt center shaft 16A (a position offset with respect to the rotation center shaft 16A).

This limits a movement of the under cover 32 so that the under cover 32 would cover the lower sides of the cushion main frame 22 and the seat cushion body 24. Further, the bottom wall of the under cover 32 is separated from the cushion main frame 22 while a gap is formed between the bottom wall of the under cover 32 and the bottom surface of the seat cushion body 24.

Now, described will be an operation of the fourth embodiment.

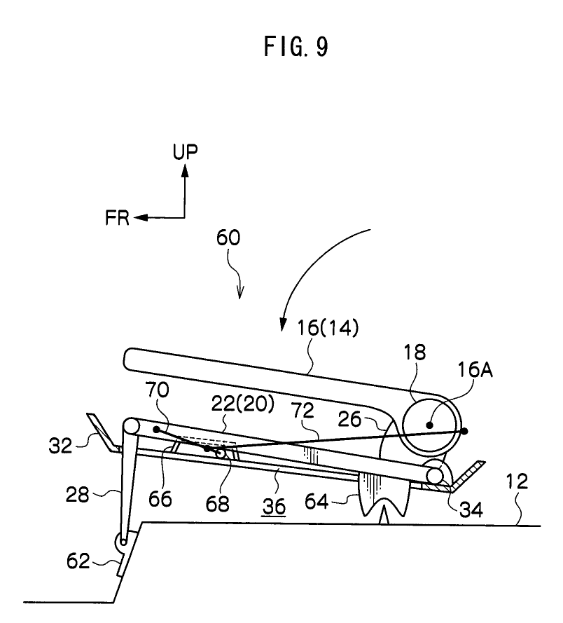

In the seat 60 having the above structure, operating the reclining mechanism 18 to tilt the seat back 14 forward upon the tilt center shaft 16A causes the seat back 14 to be superposed on the upper side of the seat cushion 20 to be stowed (refer to FIG. 9).

In stowage of the seat 60 (in tilting the back frame 16 forward), the interlocking link 72 is moved rearward, rotating the slide link 70 rearward while sliding the slide shaft 68 rearward. This allows a distance in the vertical direction (the thickness direction of the seat cushion 20) between a connection position at which the slide link 70 is connected to the cushion main frame 22 and the slide shaft 68 to be reduced, so that the distance in the vertical direction between the cushion main frame 22 and the bottom wall of the under cover 32 is reduced. This causes the seat cushion body 24 to be inserted in the under cover 32 until the bottom wall of the under cover 32 is rotated upward toward the cushion main frame 22 to become in contact with a bottom surface of the seat cushion body 24. Accordingly, the thickness of the seat cushion 20 can be reduced at the back side of the cushion main frame 22 in accordance with stowage of the seat 60 even in the case that the thickness of the seat cushion 20 in an usual use is increased.

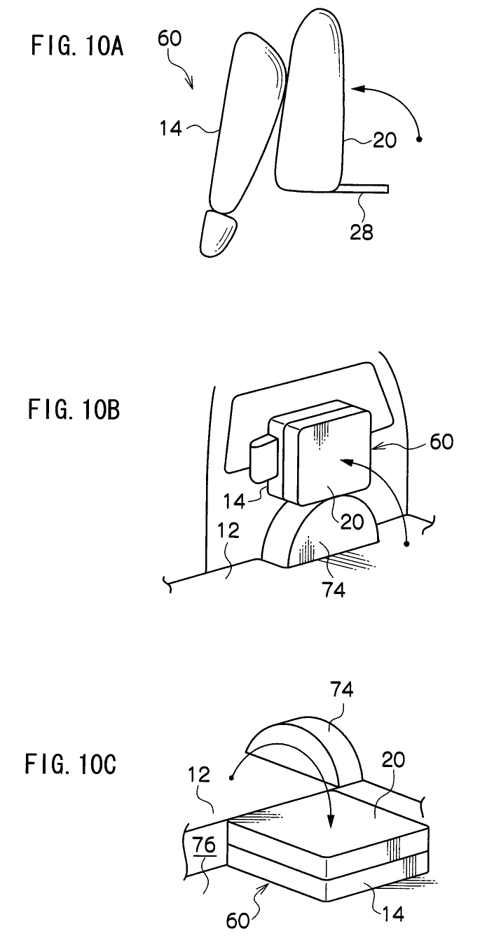

Further, as shown in FIG. 10A, for example, the seat 60 may be formed into a so-called tumble storage type so that locking of the rear locking mechanism 64 on the vehicle body side would be released after stowage of the seat 60 to rotate the seat 60 (the front link 28) forward by substantially 90 degrees, and thereby, to store the seat 60 (the seat back 14 and the seat cushion 20) forward in a state that the seat 60 is raised substantially perpendicularly. In this case, a space (spaces on the front side and the rear side of the seat 60) of a vehicle compartment (a baggage compartment) in storing the seat 60 can be increased since the seat cushion 20 is reduced in thickness in accordance with the stowage of the seat 60 as described above.

Moreover, as shown in FIG. 10B, for example, in the case that a wheel house 74 is provided on a side of the seat 60, the seat 60 may be formed into a so-called space-increasing storage type so that the lower end of the front link 28 would be separated from the front bracket 62 and locking of the rear locking mechanism 64 on the vehicle body side would be released after stowage of the seat 60 to rotate the seat 60 laterally by substantially 90 degrees, and thereby, to store the seat 60 (the seat back 14 and the seat cushion 20) on the upper side of the wheel house 74 in a state that the seat 60 is raised substantially perpendicularly. In this case, a space (a space on a side of the seat 60) of a vehicle compartment (a baggage compartment) in storing the seat 60 can be increased since the seat cushion 20 is reduced in thickness in accordance with the stowage of the seat 60 as described above.

In addition, as shown in FIG. 10C, for example, in the case that a concave 76 exists on the rear side of the seat 60, the seat 60 may be formed into a so-called rear-side under-floor storage type so that the lower end of the front link 28 would be separated from the front bracket 62 and locking of the rear locking mechanism 64 on the vehicle body side would be released after stowage of the seat 60 to rotate the seat 60 rearward by substantially 180 degrees, and thereby, to store the seat 60 (the seat back 14 and the seat cushion 20) substantially horizontally in the concave 76 in a state that the seat cushion 20 is arranged to be on the upper side of the seat back 14. In this case, a space (a space on the upper side of the seat 60) of a vehicle compartment (a baggage compartment) in storing the seat 60 can be increased while the concave 76 can be shallowed since the seat cushion 20 is reduced in thickness in accordance with the stowage of the seat 60 as described above. In the above description, exemplified has been a type in which the seat 60 is rotated by substantially 180 degrees to be stored in a rear space (the concave 76). The invention, however, may be applicable to a type in which the seat is not rotated by substantially 180 degrees to be stored in a rear space (the concave).

### Fifth Embodiment

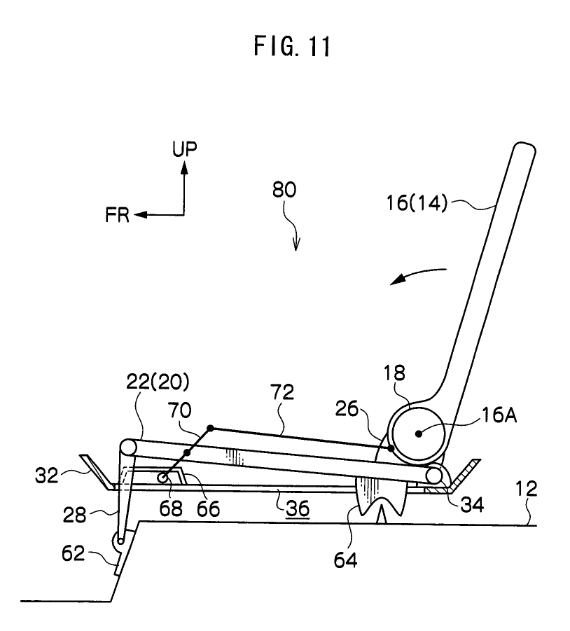

FIG. 11 is a left side view of an integral part of a seat 80 in accordance with a fifth embodiment, the seat 80 being arranged so that a seat structure in accordance with the invention would be applied to.

The seat 80 in accordance with the fifth embodiment is almost same in structure as the fourth embodiment but different in the following point.

In the case of the seat 80 in accordance with the fifth embodiment, the upper end of the slide link 70 is arranged to be disposed on the rear side of the lower end of the slide link 70. The vertically middle part of the slide link 70 is rotatably connected to both of the right and left sides (or only the right or left side) of the front part of the cushion main frame 22. Further, the upper end of the slide link 70 is rotatably connected to the front end of the interlocking link 72.

Now, described will be an operation of the fifth embodiment.

In the seat 80 having the above structure, operating the reclining mechanism 18 to tilt the seat back 14 forward upon the tilt center shaft 16A causes the seat back 14 to be superposed on the upper side of the seat cushion 20 to be stowed.

In stowage of the seat 80 (in tilting the back frame 16 forward), the interlocking link 72 is moved rearward, rotating the slide link 70 while sliding the slide shaft 68 forward. This allows a distance in the vertical direction (the thickness direction of the seat cushion 20) between a connection position at which the slide link 70 is connected to the cushion main frame 22 and the slide shaft 68 to be reduced, so that the distance in the vertical direction between the cushion main frame 22 and the bottom wall of the under cover 32 is reduced. This causes the seat cushion body 24 to be inserted in the under cover 32 until the bottom wall of the under cover 32 is rotated upward toward the cushion main frame 22 to become in contact with the bottom surface of the seat cushion body 24. Accordingly, the thickness of the seat cushion 20 can be reduced at the back side of the cushion main frame 22 in accordance with stowage of the seat 80 even in the case that the thickness of the seat cushion 20 in an usual use is increased.

This allows an effect similar to that of the above-described fourth embodiment to be achieved even in the fifth embodiment.

### Sixth Embodiment

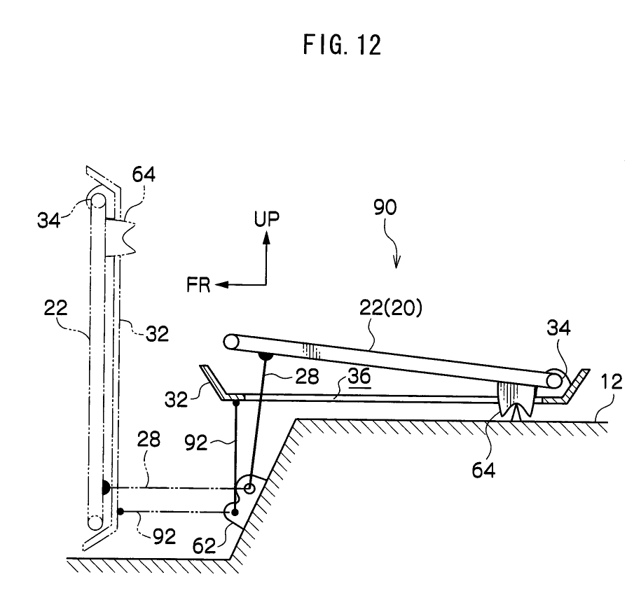

FIG. 12 is a left side view of an integral part of a seat 90 in accordance with a sixth embodiment, the seat 90 being arranged so that a seat structure in accordance with the invention would be applied to.

The seat 90 in accordance with the sixth embodiment is almost same in structure as the first embodiment but different in the following point.

In the sixth embodiment, the vehicle compartment floor surface 12 on the front side of the seat 90 is arranged to be lower than the vehicle compartment floor surface 12 just under the seat 90.

The seat 90 in accordance with the sixth embodiment is of a so-called seat cushion pull-up double-fold stowage type.

The front link 28 is used as a third link forming the link mechanism. The upper end of the front link 28 is connected to the front part of the cushion main frame 22 so as not to rotatable while the lower end of the front link 28 is rotatably connected to the front bracket 62 on the vehicle body side. Further, the front link 28 is provided with no restriction shaft 30 in accordance with the first embodiment.

The lower side of the rear part of the cushion main frame 22 is connected on both of the right and left sides to the rear locking mechanism 64 functioning as a locking mechanism. Locking the rear locking mechanism 64 on the vehicle body side causes the cushion main frame 22 to be supported on the rear locking mechanism 64 and the front link 28, and thereby, supported on the vehicle body side together with the seat cushion body 24. In the sixth embodiment, provided is no arm 26 in accordance with the first embodiment.

The front link 28 and the rear locking mechanism 64 are inserted into the opening 36 of the under cover 32. This allows the cushion main frame 22 to be connected to the vehicle body side by means of the front link 28 and the rear locking mechanism 64.

A lower side of the front part of the bottom wall of the under cover 32 is rotatably connected on both of the right and left sides to an upper end of a supporting link 92, which functions as a fourth link forming the link mechanism. A lower end of the supporting link 92 is rotatably connected to the front bracket 62 at a position offset with respect to the lower end (a center of a rotation) of the front link 28. This allows the under cover 32 to be supported on the supporting link 92 and the cushion main frame 22, and thereby, supported on the vehicle body side. Further, a movement of the under cover 32 is limited, so that the under cover 32 covers the lower sides of the cushion main frame 22 and the seat cushion body 24. Moreover, the bottom wall of the under cover 32 is separated from the cushion main frame 22 while a gap is formed between the bottom wall of the under cover 32 and the bottom surface of the seat cushion body 24.

Now, described will be an operation of the sixth embodiment.

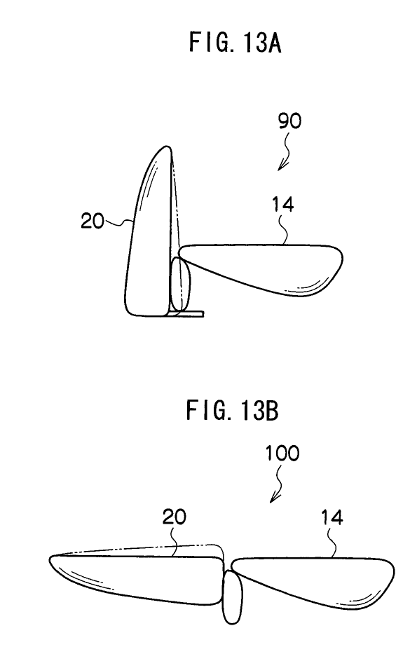

In the seat 90 having the above structure, locking of the rear locking mechanism 64 on the vehicle body side is first released to rotate the seat cushion 20 forward by substantially 90 degrees, and thereby, to raise the seat cushion 20 substantially perpendicularly. The reclining mechanism 18 is then operated to tilt the seat back 14 forward upon the tilt center shaft 16A. This allows the seat back 14 to be substantially horizontally arranged and stowed at the back side of the seat cushion 20 (refer to FIG. 13A).

In stowage of the seat 90 (in rotating the seat cushion 20 forward), the front link 28 and the supporting link 92 are rotated forward by substantially 90 degrees. This allows a distance in the thickness direction of the seat cushion 20 between a connection position at which the front link 28 is connected to the cushion main frame 22 and a connection position at which the supporting link 92 is connected to the under cover 32 to be reduced due to a difference of trucks of a rotation between the front link 28 and the supporting link 92. Accordingly, reduced is the distance in the thickness direction of the seat cushion 20 between the cushion main frame 22 and the bottom wall of the under cover 32. This causes the seat cushion body 24 to be inserted in the under cover 32 until the bottom wall of the under cover 32 is rotated toward the cushion main frame 22 with respect to the cushion main frame 22 to become in contact with the bottom surface of the seat cushion body 24. Therefore, the thickness of the seat cushion 20 can be reduced at the back side of the cushion main frame 22 in accordance with stowage of the seat 90 even in the case that the thickness of the seat cushion 20 in an usual use is increased. This allows spaces (spaces on the front and rear sides of the seat cushion 20) of a vehicle compartment (a baggage compartment) to be made large in stowing the seat 90 as well as a rearward tiltable (reclining) angle of a seat (not shown) on the front side of the seat 90 to be increased.

### Seventh Embodiment

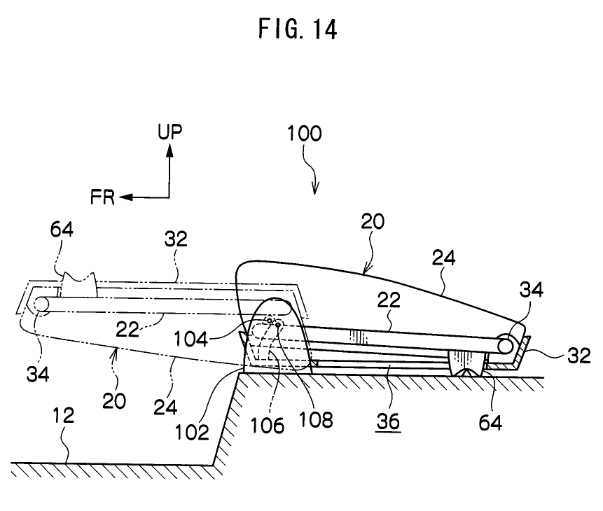

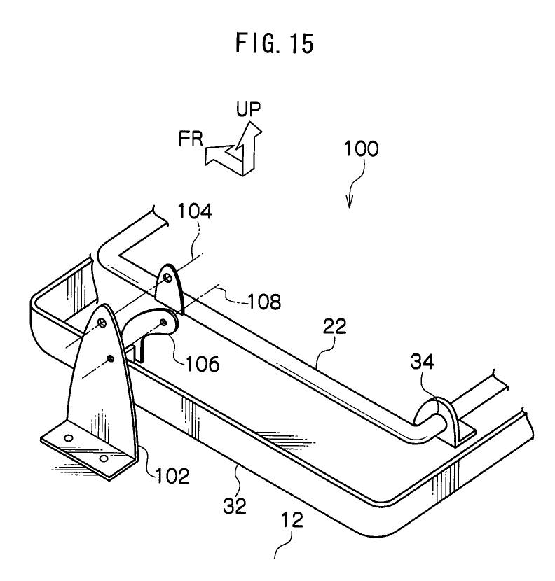

FIG. 14 is a left side view of an integral part of a seat 100 in accordance with a seventh embodiment, the seat 100 being arranged so that a seat structure in accordance with the invention would be applied to. FIG. 15 is a perspective view from the obliquely left and upper side, the view showing an integral part of the seat 100.

The seat 100 in accordance with the seventh embodiment is almost same in structure as the first embodiment but different in the following point.

The vehicle compartment floor surface 12 on the front side of the seat 100 is arranged to be lower than the vehicle compartment floor surface 12 just under the seat 100, in the seventh embodiment.

The seat 100 in accordance with the seventh embodiment is of a so-called seat cushion pull-up double-flat stowage type.

A front part of the cushion main frame 22 is rotatably connected on both of the right and left sides to a fixing bracket 102 on the vehicle body side by means of a first connection shaft 104, which functions as a first connection part forming the link mechanism.

The lower side of the rear part of the cushion main frame 22 is connected on both of the right and left sides to the rear locking mechanism 64, which functions as a locking mechanism. Locking the rear locking mechanism 64 on the vehicle body side causes the cushion main frame 22 to be supported on the rear locking mechanism 64 and the fixing bracket 102, and thereby, supported on the vehicle body side together with the seat cushion body 24.

In the seventh embodiment, provided is neither arm 26 nor front link 28 (including the restriction shaft 30) in accordance with the first embodiment.

The rear locking mechanism 64 is inserted into the opening 36 of the under cover 32. This allows the cushion main frame 22 to be connected to the vehicle body side by means of the rear locking mechanism 64.

A front part of the under cover 32 is fixed on both of the right and left sides to a lower part of a fixing link 106. An upper end of the fixing link 106 is rotatably connected to the fixing bracket 102 under a first connection shaft 104 (at a position offset with respect to the first connection shaft 104) by means of a second connection shaft 108, which functions as a second connection part forming the link mechanism. This allows the under cover 32 to be supported on the fixing bracket 102 and the cushion main frame 22, and thereby, supported on the vehicle body side. Further, a movement of the under cover 32 is limited, so that the under cover 32 covers the lower sides of the cushion main frame 22 and the seat cushion body 24. Moreover, the bottom wall of the under cover 32 is separated from the cushion main frame 22 while a gap is formed between the bottom wall of the under cover 32 and the bottom surface of the seat cushion body 24.

Now, described will be an operation of the sixth embodiment.

In the seat 100 having the above structure, locking of the rear locking mechanism 64 on the vehicle body side is first released to rotate the seat cushion 20 forward by substantially 180 degrees, and thereby, to arrange the seat cushion 20 substantially horizontally. The reclining mechanism 18 is then operated to tilt the seat back 14 forward upon the tilt center shaft 16A. This allows the seat back 14 to be substantially horizontally arranged and stowed at the back side of the seat cushion 20 (refer to FIG. 13B).

In stowage of the seat 100 (in rotating the seat cushion 20 forward), the cushion main frame 22 and the under cover 32 (including the fixing link 106) are rotated forward by substantially 180 degrees. This allows the distance in the thickness direction of the seat cushion 20 between the cushion main frame 22 and the bottom wall of the under cover 32 to be reduced due to a difference of trucks of a rotation, which is caused by a difference in diameter of a rotation between the cushion main frame 22 and the bottom wall of the under cover 32. Then, the seat cushion body 24 is inserted in the under cover 32 until the bottom wall of the under cover 32 is rotated toward the cushion main frame 22 with respect to the cushion main frame 22 to become in contact with the bottom surface of the seat cushion body 24. Therefore, the thickness of the seat cushion 20 can be reduced at the back side of the cushion main frame 22 in accordance with stowage of the seat 100 even in the case that the thickness of the seat cushion 20 in an usual use is increased. This allows a space (a space on the upper side of the seat cushion 20) of a vehicle compartment (a baggage compartment) to be made large in stowing the seat 100 as well as interference of the seat cushion 20 with the vehicle compartment floor surface 12 to be prevented.

### Eighth Embodiment

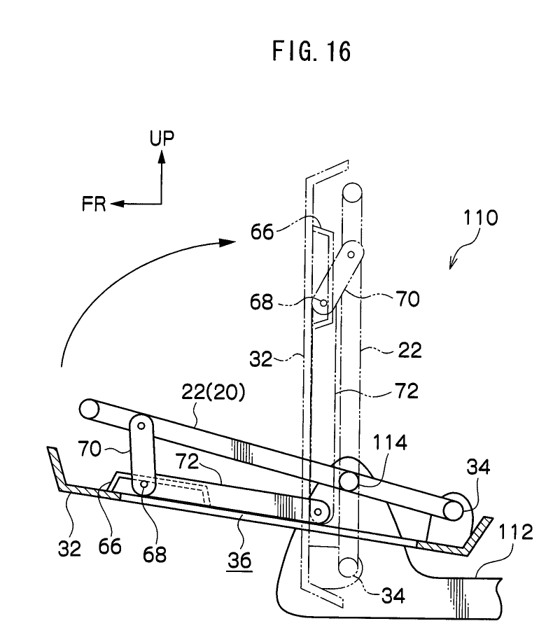

FIG. 16 is a left side view of an integral part of a seat 110 in accordance with a eighth embodiment, the seat 110 being arranged so that a seat structure in accordance with the invention would be applied to.

The seat 110 in accordance with the eighth embodiment is almost same in structure as the first embodiment but different in the following point.

The seat 110 in accordance with the eighth embodiment is of a so-called seat cushion jumping tip-up stowage type.

A middle part of the cushion main frame 22 in the back-and-forth direction is rotatably connected on both of the right and left sides to a leg 112 on the vehicle body side by means of a third connection shaft 114, which functions as a third connection part forming the link mechanism. This allows the cushion main frame 22 to be supported on the leg 112, and thereby, the seat cushion 20 to be supported on the vehicle body side. The leg 112 is provided with a rotation locking mechanism (omitted from drawing), which functions as a locking mechanism. The rotation locking mechanism interrupts a rotation of the cushion main frame 22.

In the eighth embodiment, provided is neither arm 26 nor front link 28 (including the restriction shaft 30) in accordance with the first embodiment.

In the vicinity of the front part of the upper surface of the under wall of the under cover 32, fixed on both of the right and left sides (or only on the right or left side) is the guide plate 66, which has a cross section in the shape of a reverse U-shaped plate and functions as a guide member. An upper wall of the guide plate 66 is formed into the shape of a flat plate. In the guide plate 66, inserted is the slide shaft 68, which is in the shape of a circular shaft and functions as a slide member. The slide shaft 68 is capable of sliding between the bottom wall of the under cover 32 and the upper wall of the guide plate 66.

An end of the slide shaft 68 is connected to the lower end of the slide link 70, which functions as a fifth link forming the link mechanism. This allows the lower end of the slide link 70 to be slidably connected to the under cover 32. The upper end of the slide link 70 is arranged to be disposed on the front side of the lower end of the slide link 70. The upper end of the slide link 70 is rotatably connected to both of the right and left sides (or only the right or left side) of the front part of the cushion main frame 22.

An end of the slide shaft 68 is rotatably connected to the front end of the interlocking link 72, which functions as a sixth link forming the link mechanism. The rear end of the interlocking link 72 is rotatably connected to the leg 112 under the third connection shaft 114 (a position offset with respect to the third connection shaft 114). This limits a movement of the under cover 32 so that the under cover 32 would cover the lower sides of the cushion main frame 22 and the seat cushion body 24. Further, the main cushion frame 22 is separated from the bottom wall of the under cover 32 while a gap is formed between the bottom surface of the seat cushion body 24 and the bottom wall of the under cover 32.

Now, described will be an operation of the eighth embodiment.

In the seat 110 having the above structure, interruption of a rotation of the cushion main frame 22 by a rotation locking mechanism is released while the seat cushion 20 is rotated rearward by substantially 90 degrees to raise the seat cushion 20 substantially perpendicularly. This causes the seat cushion 20 to be superposed on the front side of the seat back 14 to be stowed.

In stowage of the seat 110 (in rotating the seat cushion 20 rearward), the cushion main frame 22, the under cover 32 and the interlocking link 72 are rotated rearward by substantially 90 degrees. The slide shaft 68 is then slid toward the leg 112 together with the interlocking link 72 due to a difference in tracks of a rotation between the cushion main frame 22 and the interlocking link 72. This causes the slide link 70 to be rotated to a leg 112 side. This allows a distance in the thickness direction of the seat cushion 20 between a connection position at which the slide link 70 is connected to the cushion main frame 22 and the slide shaft 68 to be reduced, so that the distance in the thickness direction of the seat cushion 20 between the cushion main frame 22 and the bottom wall of the under cover 32 is reduced. Accordingly, the thickness of the seat cushion 20 can be reduced at the back side of the cushion main frame 22 in accordance with stowage of the seat 110 even in the case that the thickness of the seat cushion 20 in an usual use is increased. This allows the thickness of the seat 110 (the seat cushion 20 and the seat back 14) in the back-and-forth direction to be thinned in stowing the seat 110 as well as spaces (spaces on the front side and the rear side of the seat cushion 20) of a vehicle compartment (a baggage compartment) to be made large in stowing the seat 110.

### Ninth Embodiment

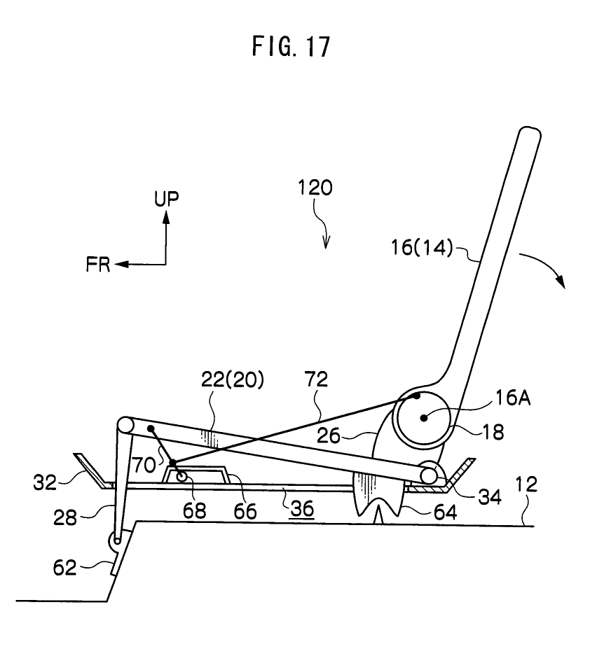

FIG. 17 is a left side view of an integral part of a seat 120 in accordance with a ninth embodiment, the seat 120 being arranged so that a seat structure in accordance with the invention would be applied to.

The seat 120 in accordance with the ninth embodiment is almost same in structure as the fourth embodiment but different in the following point.

The seat 120 in accordance with the ninth embodiment is of a so-called seat back rearward-tilt full-flat stowage type.

A rear end of the interlocking link 72 is rotatably connected to the lower part of the seat back 14 above the tilt center shaft 16A (at a position offset with respect to the tilt center shaft 16A).

Now, described will be an operation of the ninth embodiment.

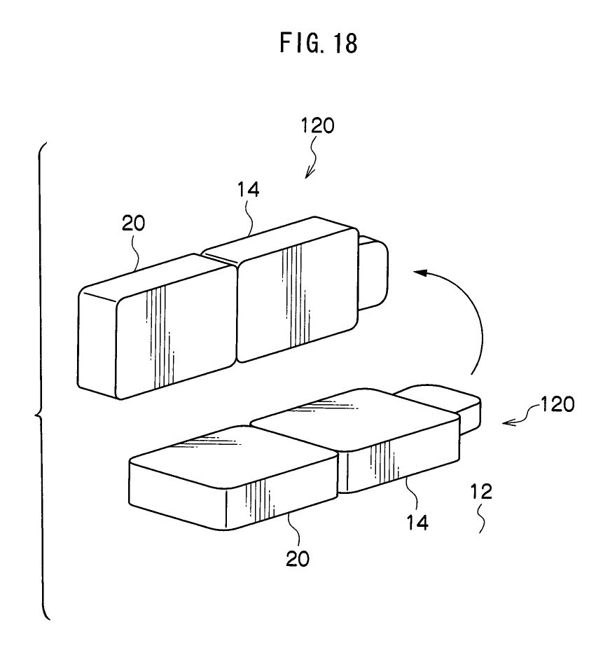

In the seat 120 having the above structure, operating the reclining mechanism 18 to tilt the seat back 14 rearward upon the tilt center shaft 16A causes the seat back 14 to be arranged substantially horizontally at the back side of the seat cushion 20 for stowage (refer to FIG. 18).

In stowage of the seat 120 (in tilting the back frame 16 rearward), the interlocking link 72 is moved rearward, rotating the slide link 70 rearward while sliding the slide shaft 68 rearward. This allows a distance in the vertical direction (a thickness direction of the seat cushion 20) between a connection position at which the slide link 70 is connected to the cushion main frame 22 and the slide shaft 68 to be reduced, so that the distance in the vertical direction between the cushion main frame 22 and the bottom wall of the under cover 32 is reduced. This causes the seat cushion body 24 to be inserted in the under cover 32 until the bottom wall of the under cover 32 is rotated upward toward the cushion main frame 22 to become in contact with the bottom surface of the seat cushion body 24. Accordingly, the thickness of the seat cushion 20 can be reduced in accordance with stowage of the seat 120 even in the case that the thickness of the seat cushion 20 in an usual use is increased.

In addition, as shown in FIG. 18, for example, the seat 120 may be formed into a space-increasing storage type so that the lower end of the front link 28 would be separated from the front bracket 62 and locking of the rear locking mechanism 64 on the vehicle body side would be released after stowage of the seat 120, and then, the seat 120 (the seat back 14 and the seat cushion 20) would be rotated laterally by substantially 90 degrees to be stored in the vicinity of a side surface of a vehicle compartment with the seat 120 being raised substantially perpendicularly. In this case, a space (a space on a side of the seat cushion 20) of a vehicle compartment (a baggage compartment) in storing the seat 120 can be increased since the seat cushion 20 is reduced in thickness in accordance with the stowage of the seat 120 as described above.

### Tenth Embodiment

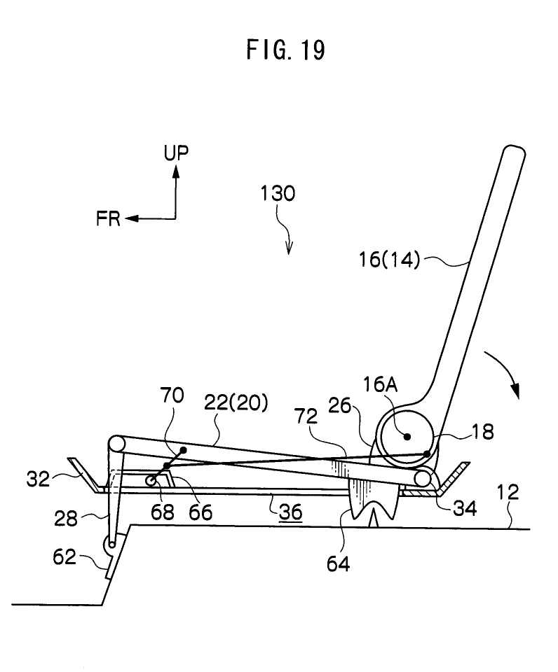

FIG. 19 is a left side view of an integral part of a seat 130 in accordance with a tenth embodiment, the seat 130 being arranged so that a seat structure in accordance with the invention would be applied to.

The seat 130 in accordance with the tenth embodiment is almost same in structure as the ninth embodiment but different in the following point.

In the case of the seat 130 in accordance with the tenth embodiment, the upper end of the slide link 70 is arranged to be disposed on the rear side of the lower end of the slide link 70.

The rear end of the interlocking link 72 is rotatably connected to the lower part of the seat back 14 under the tilt center shaft 16A (at a position offset with respect to the tilt center shaft 16A).

Now, described will be an operation of the tenth embodiment.

In the seat 130 having the above structure, operating the reclining mechanism 18 to tilt the seat back 14 rearward upon the tilt center shaft 16A causes the seat back 14 to be arranged substantially horizontally on the rear side of the seat cushion 20 for stowage.

In stowage of the seat 130 (in tilting the back frame 16 rearward), the interlocking link 72 is moved forward, rotating the slide link 70 forward while sliding the slide shaft 68 forward. This causes the slide shaft 68 to rotate clockwise with respect to a connection position at which the slide link 70 is connected to the cushion main frame 22, similarly to a direction of a tilt of the back frame 16. Accordingly, a distance in the vertical direction (a thickness direction of the seat cushion 20) between the connection position and the slide shaft 68 is reduced, so that the distance in the vertical direction between the cushion main frame 22 and the bottom wall of the under cover 32 is reduced. That is to say, the seat cushion body 24 is inserted in the under cover 32 until the bottom wall of the under cover 32 is rotated upward toward the cushion main frame 22 to become in contact with the bottom surface of the seat cushion body 24.

This allows an effect similar to that of the ninth embodiment to be achieved even in the tenth embodiment.

### INDUSTRIAL APPLICABILITY

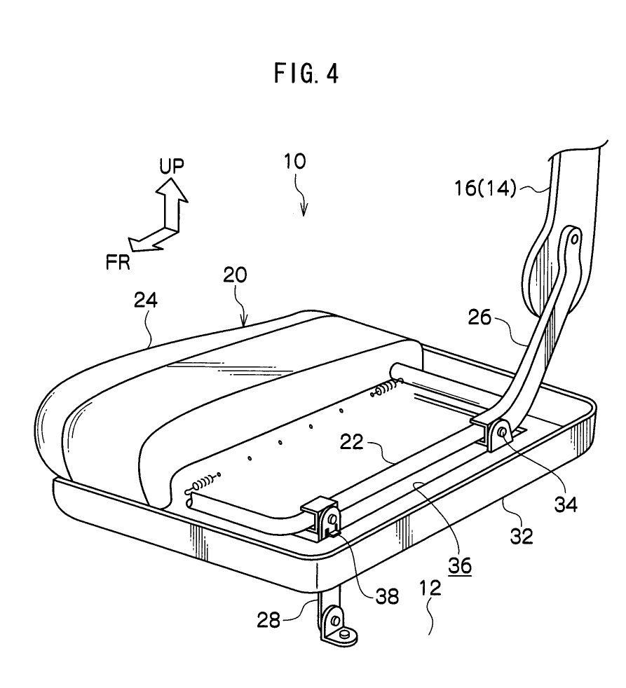

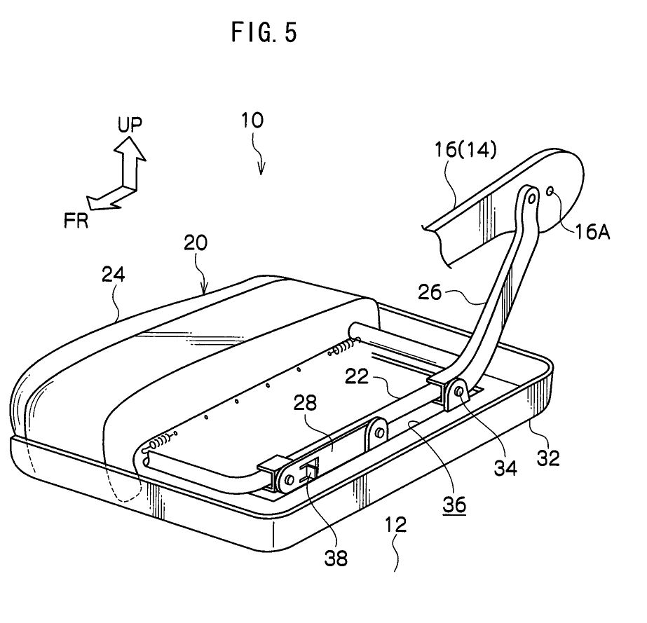

In accordance with the first embodiment, the circular shaft-shaped restriction shaft 30 functioning as a contact part is arranged to be fixed to the front link 28. It may be arranged, however, that a plate-shaped restriction plate 38 functioning as a contact part be formed in the front link 28 by a so-called cutting and raising method, as shown in FIGS. 4 and 5.

Further, in the first and second embodiments, the front link 28 is arranged to be rotatably connected to the cushion main frame 22. The front link 28, however, may be arranged to be rotatably connected to the under cover 32. In this case, the restriction shaft 30 of the front link 28 is arranged so as to contact with the cushion main frame 22.

Moreover, the front link 28 is arranged to be provided with the restriction shaft 30 (the contact part) in the first and second embodiments. The front link 28, however, may be arranged to be provided with no contact part.

In addition, it is arranged that the rear end of the interlocking link 72 is rotatably connected to the leg 112 under the third connection shaft 114 in the eighth embodiment. The rear end of the interlocking link 72, however, may be arranged to be rotatably connected to the leg 112 above the third connection shaft 114. In this case, the upper end of the slide link 70 is preferably provided on the rear side of the lower end of the slide link 70.

Besides, the slide link 70 is slidably connected to the under cover 32 while the slide link 70 is rotatably connected to the cushion main frame 22 in the fourth, fifth and eighth to tenth embodiments. The slide link 70, however, my be arranged to be rotatably connected to the under cover 32 and slidably connected to the cushion main frame 22. In this case, the interlocking link 72 is arranged to be rotatably connected to a place other than a connection position at which the slide link 70 is connected to the under cover 32.

1. A seat structure comprising:
a seat cushion frame provided in a seat cushion;
a back side member provided to the seat cushion at the back side of the seat cushion frame to be connected to the seat cushion frame independently from support of the seat cushion frame on a vehicle body side; and
a link mechanism for moving the back side member to extend/retract a distance between the seat cushion frame and the back side member in the thickness direction of the seat cushion.

2. The seat structure according to claim 1, wherein the link mechanism includes:
a link rotatably connected to the vehicle body side and rotatably connected to one of the seat cushion frame or the back side member; and
a contact part provided to the link that contacts with the other of the seat cushion frame or the back side member and that separates the other of the seat cushion frame or the back side member from the one of the seat cushion frame or the back side member.

3. The seat structure according to claim 1, further comprising a seat back arranged so as to be tiltable, wherein the link mechanism includes:
a first link rotatably connected to one of the seat cushion frame or the back side member and slidably connected to the other of the seat cushion frame or the back side member; and
a second link rotatably connected to the seat back at a position offset with respect to the center of tilting and rotatably connected to the first link.

4. (canceled)

5. (canceled)

6. (canceled)

7. (canceled)

8. A seat extension/retraction method, the method comprising, in a seat structure comprising a seat cushion frame provided in a seat cushion and a back side member provided to the seat cushion at the back side of the seat cushion frame to be connected to the seat cushion frame independently from support of the seat cushion frame on a vehicle body side,
moving the back side member to extend/retract a distance between the seat cushion frame and the back side member in a thickness direction of the seat cushion via a link mechanism.

9. The seat extension/retraction method according to claim 8, wherein the link mechanism includes:
a link rotatably connected to the vehicle body side and rotatably connected to one of the seat cushion frame or the back side member; and
a contact part provided to the link that contacts with the other of the seat cushion frame or the back side member and that separates the other of the seat cushion frame or the back side member from the one of the seat cushion frame or the back side member.

10. The seat extension/retraction method according to claim 8, further comprising a seat back arranged so as to be tiltable, wherein the link mechanism includes:
a first link rotatably connected to one of the seat cushion frame or the back side member and slidably connected to the other of the seat cushion frame or the back side member; and
a second link rotatably connected to the seat back at a position offset with respect to the center of tilting and rotatably connected to the first link.

11. (canceled)

12. (canceled)

13. (canceled)

14. (canceled)

15. A vehicle provided with a seat having the seat structure according to claim 1.

16. The seat structure according to claim 1, wherein operating the link mechanism in accordance with a rotation of the seat cushion frame with respect to the vehicle body side.

17. The seat structure according to claim 16, wherein the link mechanism includes:
a third link rotatably connected to the vehicle body side and connected to the seat cushion frame; and
a fourth link rotatably connected to the vehicle body side at a position offset with respect to the center of rotation of the third link and connected to the back side member.

18. The seat structure according to claim 16, wherein the link mechanism includes:
a first connection part that rotatably connects the seat cushion frame to the vehicle body side; and
a second connection part that rotatably connects the back side member to the vehicle body side at a position offset with respect to the center of rotation of the seat cushion frame.

19. The seat structure according to claim 16, wherein the link mechanism includes:
a third connection part for rotatably connecting one of the seat cushion frame or the back side member to the vehicle body side;
a fifth link rotatably connected to the vehicle body side at a position offset with respect to the center of rotation of the one of the seat cushion frame or the back side member and slidably connected to the other of the seat cushion frame or the back side member; and
a sixth link rotatably connected to the one of the seat cushion frame or the back side member and rotatably connected to the fifth link.

20. The seat structure according to any one of claims 1 to 3 and 16 to 19, further comprising a cover member for covering an outer circumferential surface of the back side member.

21. The seat extension/retraction method according to claim 8, wherein operating the link mechanism in accordance with a rotation of the seat cushion frame with respect to the vehicle body side.

22. The seat extension/retraction method according to claim 21, wherein the link mechanism includes:
a third link rotatably connected to the vehicle body side and connected to the seat cushion frame; and
a fourth link rotatably connected to the vehicle body side at a position offset with respect to the center of rotation of the third link and connected to the back side member.

23. The seat extension/retraction method according to claim 21, wherein the link mechanism includes:
a first connection part that rotatably connects the seat cushion frame to the vehicle body side; and
a second connection part that rotatably connects the back side member to the vehicle body side at a position offset with respect to the center of rotation of the seat cushion frame.

24. The seat extension/retraction method according to claim 21, wherein the link mechanism includes:
a third connection part that rotatably connects one of the seat cushion frame or the back side member to the vehicle body side;
a fifth link rotatably connected to the vehicle body side at a position offset with respect to the center of rotation of the one of the seat cushion frame or the back side member and slidably connected to the other of the seat cushion frame or the back side member; and
a sixth link rotatably connected to the one of the seat cushion frame or the back side member and rotatably connected to the fifth link.

25. The seat extension/retraction method according to any one of claims 8 to 10 and 21 to 24, further comprising a cover member that covers an outer circumferential surface of the back side member.
